(19) United States
(12) Patent Application Publication
(10) Pub. No.: US 2007/0190951 A1
(43) Pub. Date: Aug. 16, 2007

(54) Data transmission method, transceiver and telecommunication system

(75) Inventors: Marko Lampinen, Oulu (FI); Markku Kuusela, Espoo (FI); Jorma Kaikkonen, Oulu (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/653,294

(22) Filed: Jan. 16, 2007

(30) Foreign Application Priority Data
Feb. 13, 2006 (FI) 20065108

(51) Int. Cl. H04B 1/02; H04M 1/00; H04B 7/02

(52) U.S. Cl. 455/101; 455/562.1

(57) ABSTRACT

A transceiver and a method of controlling data transmission in a radio system, the method comprising transmitting packets from a first transceiver to a second transceiver, each packet having a given quality of service value. The first transceiver selects a stream of two or more available streams realized with a plurality of transmit antenna paths for the transmission of each packet on the basis of the quality of service value of each packet and the channel quality information of each available stream.

### FIELD

The invention relates to a data transmission in a telecommunication system, where packets are transmitted from a transceiver to another utilising at least two streams realized with a plurality of transmit antenna paths.

### BACKGROUND

Communication systems, and a wireless communication system in particular, have been under extensive development in recent years. Several new services have been developed in addition to the conventional speech transmission. Different data and multimedia services are attractive to users, and communication systems should provide sufficient quality of service at a reasonable cost.

The new developing services require high data rates and spectral efficiency at a reasonable computational complexity. One proposed solution is the use of multiple antennas or antenna transmit paths in transceivers, such as in a mobile station as well as in a base station (or an equivalent access point to a communication network) serving the mobile station. The use of multiple antenna transmit paths in transceivers, transmitters and receivers enables “multiple input multiple output” (MIMO) communication. MIMO communication has been introduced into wireless communications in order to improve the spectral efficiency of communication. With the use of multiple transmit paths, the transceiver or a transmitter may utilise more than one stream in transmission. The use of streams may significantly increase the capacity and reliability of transmission.

However, significant throughput gains from MIMO processing are obtainable only with high signal to noise ratios (SNR) of the transmitted signal. In order to also guarantee the performance with low SNR values, different multiplexing schemes have been proposed for use with MIMO. In systems utilizing packet-switched connections, transmitted packets are usually protected against noise, fading and interference by channel coding, such as FEC (Forward Error correction Coding). In spite of protection, failure may occur in the reception of a packet, which can be compensated for by retransmission. Re-transmission takes place when a receiving transceiver of packets requests a faulty packet to be repeated. This can be performed by an ARQ (Automatic Repeat reQuest) mechanism. In a receiver utilizing HARQ (Hybrid ARQ), a faulty packet and a retransmitted packet can be combined. The combining can be especially effective if different transmissions of the same packet are utilized in decoding.

Present solutions do not take the varying radio channel conditions between different streams into account. Thus, the available throughput and quality of service are not maximised.

### BRIEF DESCRIPTION OF THE INVENTION

An object of the invention is to provide an improved solution for controlling data transmission in a radio system. According to an aspect of the invention, there is provided a method of controlling data transmission in a radio system, the method comprising: transmitting packets from a first transceiver to a second transceiver, each packet having a given quality of service value, selecting in the first transceiver a stream of two or more available streams realized with a plurality of transmit antenna paths for the transmission of each packet on the basis of the quality of service value of each packet and the channel quality information of each available stream.

According to another aspect of the invention, there is provided a transceiver of a telecommunication system, the transceiver comprising: a transmitter for transmitting packets to a second transceiver, each packet having a given quality of service value; a plurality of transmit antenna paths operationally connected to the transmitter; a controller, operationally connected to the transmitter, for selecting a stream of two or more available streams realized with a plurality of transmit antenna paths for the transmission of each packet on the basis of the quality of service value of each packet and the channel quality information of each available stream.

According to another aspect of the invention, there is provided a telecommunication system, comprising a first and a second transceiver, the first transceiver comprising: a transmitter for transmitting packets to a second transceiver, each packet having a given quality of service value; a plurality of transmit antenna paths operationally connected to the transmitter. The first transceiver is configured to select a stream of two or more available streams realized with a plurality of transmit antenna paths for the transmission of each packet on the basis of the quality of service value of each packet and the channel quality information of each available stream.

According to another aspect of the invention, there is provided a base station of a telecommunication system, the base station comprising: a transmitter for transmitting packets, each packet having a given quality of service value; a plurality of transmit antenna paths operationally connected to the transmitter; a controller, operationally connected to the transmitter, for selecting a stream of two or more available streams realized with a plurality of transmit antenna paths for the transmission of each packet on the basis of the quality of service value of each packet and the channel quality information of each available stream.

According to another aspect of the invention, there is provided a data transmission method in a telecommunication system, the method comprising: transmitting packets from a first transceiver to a second transceiver utilising a transmit antenna path of at least two available transmit antenna paths; detecting a failure in the reception in the second transceiver; transmitting, from the second transceiver to the first transceiver, a request to retransmit at least one packet having failure in reception; transmitting, from the second transceiver to the first transceiver, information about the quality of the signal sent using different transmit antenna paths; selecting a transmit antenna path on the basis of the information; retransmitting from the first transceiver at least one packet requested in response to the request utilising the selected transmit antenna path.

According to another aspect of the invention, there is provided a telecommunication system comprising a first and a second transceiver, the first transceiver being configured to transmit packets to the second transceiver utilising one or more transmit antenna paths from a plurality of transmit antenna paths; the second transceiver being configured to detect a failure in reception; transmit to the first transceiver a request to retransmit at least one packet having failure in reception; transmit to the first transceiver information about the quality of the signal sent using different transmit antenna paths; the first transceiver is further configured to select a transmit antenna path on the basis of the information; retransmit at least one packet requested in response to the request utilising the selected transmit antenna path.

According to another aspect of the invention, there is provided a data transmission method in a transceiver of a telecommunication system, the method comprising: transmitting packets to a another transceiver utilising one or more transmit antenna paths from a plurality of transmit antenna paths; receiving from the other transceiver a request to retransmit at least one packet having failure in reception and information about the quality of the signal sent using different transmit antenna paths; selecting a transmit antenna path on the basis of the information; retransmitting at least one packet requested in response to the request utilising the selected transmit antenna path.

According to another aspect of the invention, there is provided a transceiver of a telecommunication system, the transceiver comprising: a transmitter for transmitting packets to another transceiver utilising one or more transmit antenna paths from a plurality of transmit antenna paths; a receiver, operationally connected to the transmitter, for receiving from the other transceiver a request to retransmit at least one packet having failure in reception and information about the quality of the signal sent using different transmit antenna paths; a controller, operationally connected to the transmitter and the receiver, for selecting a transmit antenna path on the basis of the information and for controlling the transmitter to retransmit at least one packet requested in response to the request utilising the selected transmit antenna path.

According to yet another aspect of the invention, there is provided a transmitter of a telecommunication system, the transmitter comprising a plurality of transmit antenna paths, the transmitter being configured to transmit packets, each packet having a given quality of service value and to select a stream of two or more available streams realized with a plurality of transmit antenna paths for the transmission of each packet on the basis of the quality of service value of each packet and the channel quality information of each available stream.

According to yet another aspect of the invention, there is provided a base station of a telecommunication system, the base station comprising: a transmitter for transmitting packets to another transceiver utilising one or more transmit antenna paths from a plurality of transmit antenna paths; a receiver, operationally connected to the receiver, for receiving from the other transceiver a request to retransmit at least one packet having failure in reception and information about the quality of the signal sent using different transmit antenna paths; a controller, operationally connected to the transmitter and the receiver, for selecting a transmit antenna path on the basis of the information and for controlling the transmitter to retransmit at least one packet requested in response to the request utilising the selected transmit antenna path.

The invention provides several advantages. The service quality and system capacity of the radio system are improved especially in difficult channel conditions.

In an embodiment of the invention, the performance of a spatial multiplexing scheme utilizing multi-stream transmission may be improved by selecting the transmit antenna stream during HARQ transmissions. This selection may be based on the measurements made by mobile stations or it may be based on a service quality criteria.

In case of multi-stream transmission, the HARQ retransmissions may be transmitted via a selected transmit antenna. Transmit antenna can be selected via measurements made by the mobile station receiving the transmission. The antennas for the re-transmissions can be selected so that instantaneous throughput is maximized for the mobile station.

### LIST OF DRAWINGS

In the following, the invention will be described in greater detail with reference to the embodiments and the accompanying drawings, in which

FIG. 1A illustrates the structure of a telecommunication system used as an example,

FIG. 1B illustrates in more detail the structure of the telecommunication system used as an example,

FIG. 2 illustrates an example of an embodiment of the invention,

FIG. 3 is a flow chart illustrating an embodiment of the invention,

FIG. 4 illustrates a more detailed example of an embodiment, and

FIG. 5 is a flow chart illustrating another embodiment of the invention.

### DESCRIPTION OF EMBODIMENTS

The present invention is applicable to various telecommunication systems, in which transceivers are capable of transmitting with more than one transmission antenna path. Embodiments of the invention may be utilised in transceivers, transmitters and receivers. Typical examples of a system to which the invention can be applied are evolutions of the third-generation cellular telecommunication systems, UMTS (Universal Mobile Telecommunications System). However, the invention is not limited to UMTS or any other cellular telecommunications system, as one skilled in the art understands.

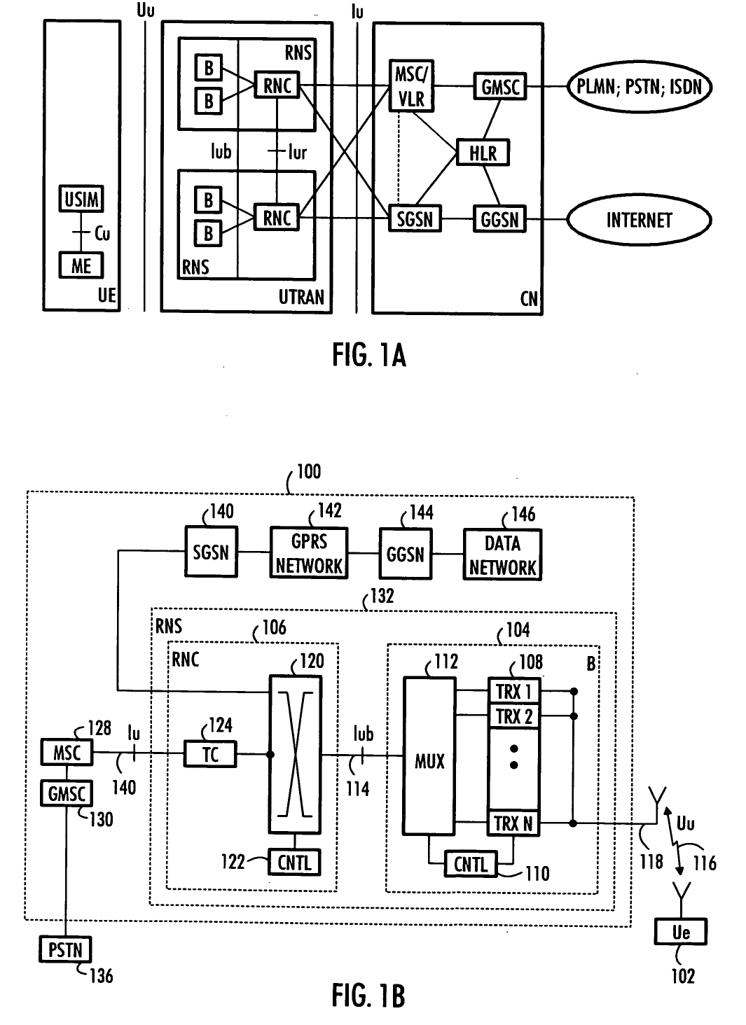

The structure of the UMTS mobile telephone system, used as an example of a system to which the embodiments of the invention are applicable, will be described with reference to FIG. 1A.

The main parts of a mobile telephone system are a core network CN, a UMTS terrestrial radio access network UTRAN and user equipment UE. The interface between the core network CN and the radio access network UTRAN is called lu, and the air interface between the UTRAN and the UE is called Uu.

The user equipment UE is composed of two parts: mobile equipment ME comprising a radio terminal used to establish a radio link over the interface Uu and a UMTS subscriber identity module USIM which is a smart card comprising data on the identity of the subscriber and typically performs identification algorithms, stores encryption parameters and subscriber data.

The UTRAN is composed of radio network subsystems RNS. An RNS is composed of a radio network controller RNC and one or more nodes B. In practice, node B refers to a base station. The radio network controller RNC manages radio resources by base stations connected thereto.

The core network CN is composed of several parts. A home location register HLR is a database in a subscriber's home system for maintaining a user service profile. The home location register also maintains data on user locations with the accuracy of an MSC. A mobile services switching centre/visitor location register MSCNLR is a switch (MSC) and a database (VLR) servicing the terminal equipment as regards circuit-switched (CS) services. The MSC switches circuit-switched services and the VLR maintains data on the user profile and location. A gateway MSC GMSC is, in turn, a switch connecting the UMTS to external services or networks. All circuit-switched connections are switched via the GMSC. The functionality of a serving GPRS (General Packet Radio Service) support node SGSN corresponds to the functionality of the MSC/VLR, but it forwards packet-switched (PS) connections. Correspondingly, a gateway GPRS support node GGSN corresponds functionally to the GMSC, but as regards packet-switched connections. External networks can be divided into two types: circuit-switched networks, such as existing telephone networks, and packet-switched networks, such as the Internet.

The UTMS comprises several specified interfaces. A Cu interface is located between the smart card USIM and the mobile equipment ME. The Uu interface is located between the terminal equipment and the base station. The interface between the core network CN and the radio access network UTRAN is called lu. The interface between the radio network subsystems RNS is called lur. This enables soft handovers between the radio network controllers of different manufacturers. The interface between a radio network controller RNC and a base station B is called lub.

FIG. 1A shows the structure on quite a general level, wherefore it will be illustrated in more detail in FIG. 1B by means of an example of a cellular radio system. FIG. 1B only shows the essential blocks, but it is apparent to a person skilled in the art that a conventional cellular radio network also includes a number of other functions and structures, which do not have to be described in more detail herein. It should also be noted that FIG. 1B shows only an exemplary structure. The details of the systems according to the invention may differ from those shown in FIG. 1B, but such differences are not of significance to the invention.

A cellular radio network typically comprises a fixed network infrastructure, i.e. a network part 100, and terminal equipment 102, which can be fixed, vehicle-mounted or portable. The network part 100 includes base stations 104. A base station corresponds to node B shown in the previous figure. Several base stations 104 are controlled in a centralized manner by a radio network controller 106 communicating with them. A base station 104 comprises transceivers 108 and a multiplexer unit 112.

The base station 104 further comprises a control unit 110, which controls the operation of the transceivers or transmitters and receivers 108 and the multiplexer 112. The multiplexer 112 is used to place the traffic and control channels used by several transceivers 108 to a common transmission link 114. The transmission link 114 forms the lub interface.

The transceivers 108 of the base station 104 communicate with an antenna unit 118, which implements a bi-directional radio connection 116 to the terminal equipment 102. The structure of the frames to be transmitted over the bi-directional radio connection 116 is specified system-specifically, and it is referred to as an air interface Uu. In the preferred embodiments of the invention, at least a part of a signal is transmitted by means of three or more transmit antennas or three or more beams provided by several transmit antennas.

The radio network controller 106 comprises a group switching field 120 and a control unit 122. The group switching field 120 is used to switch speech and data and to connect signalling circuits. A radio network subsystem 132 formed by the base station 104 and the radio network controller 106 also includes a transcoder 124. The transcoder 124 is usually located as close to the mobile services switching centre 128 as possible, since speech can thus be transmitted in the cellular network format between the transcoder 124 and the radio network controller 106, thus saving transmission capacity.

The transcoder 124 transforms the different digital speech coding formats used between a public switched telephone network and a mobile telephone network to be compatible with one another, e.g. from the fixed network format to some other format of a cellular radio network, and vice versa. The control unit 122 performs call control, mobility management, gathering of statistical data and signalling.

As shown in FIG. 1B, the group switching field 120 is used to carry out switching both to a public switched telephone network (PSTN) 136 via the mobile services switching centre 128 and a gateway MSC 130 and to a packet transmission network 142.

The connection between the packet transmission network 142 and the group switching field 120 is established by an SGSN (Serving GPRS Support Node) 140. The function of the support node 140 is to transfer packets between the base station system and a GGSN (Gateway GPRS Support Node) 144, and to keep record of the terminal equipment's 102 location within its area.

The gateway node 144 connects a public packet transmission network 146 with the packet transmission network 142. An Internet protocol or an X.25 protocol can be used at the interface. The gateway node 144 encapsulates the inner structure of the packet transmission network 142 to conceal it from the public packet transmission network 146, and, therefore, the public packet transmission network 146 sees the packet transmission network 142 as a subnetwork, and the public packet transmission network can address packets to and receive them from the terminal equipment 102 located in the network.

The packet transmission network 142 is typically a private network employing an Internet protocol and carrying signalling and tunnelled user data. Below the Internet protocol layer, both the architecture and protocols of the network structure 142 may vary according to operator. The public packet transmission network 146 may be the global Internet, for example.

The terminal equipment 102 includes at least one transceiver that implements the radio connection to the network part 100 or to the base station 104. In addition, the mobile station 102 typically comprises an antenna, a processor controlling the operation of the device and a battery. Different mobile stations 102 with various properties currently exist, for instance vehicle-mounted and portable terminals.

Embodiments of the invention may be applied to a communication system utilizing packet transmission, where packets are transmitted from a transceiver to another utilising at least two streams realized with a plurality of transmit antenna paths. The plurality of transmit antenna paths may be realised with a plurality of antennas or an antenna array in the base stations 110, 112 and 114 and in the terminal equipment 102.

UMTS defines a High Speed Downlink Packet Access (HSDPA) method, in which embodiments of the invention may be utilized. In the following, embodiments of the invention are described in connection with HSDPA. A person skilled in the art is aware that embodiments of the invention may be applied to uplink transmission and other systems as well.

Hybrid Automatic Repeat reQuest (HARQ) is a technique used in increasing the throughput of packet communication systems that support high data rates. If a receiver receives a packet correctly in a communication system using HARQ, the receiver feeds back a positive acknowledgement (ACK) to the transmitter. Otherwise, the receiver feeds back a negative acknowledgement (NAK) and stores the received packet. If the transmitter receives an ACK, a retransmission is unnecessary. If, on the other hand, the transmitter receives an NAK, the transmitter retransmits the packet. Thus, the receiver receives the retransmitted packet and soft-combines the symbols of the retransmitted packet with the symbols of the packet that was previously received and stored in the receiver. The soft-combining greatly reduces the error rate of the retransmissions. An adaptive HARQ is one HARQ technique in which the data rate at each transmission (including each retransmission) is adaptive.

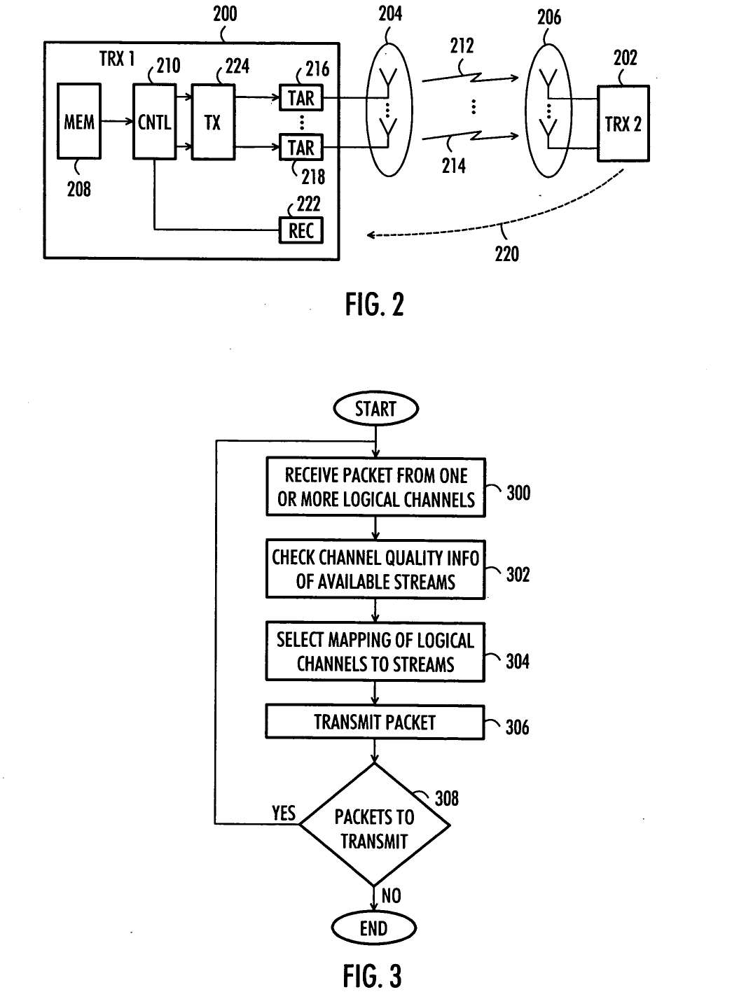

FIG. 2 illustrates an example of an embodiment of the invention. A first transceiver 200 transmits packets to a second transceiver 202. In this example, both transceivers utilize more than one antenna 204, 206 in transmission and reception. In some embodiments, the second transceiver utilizes only one antenna. The first transceiver 200 comprises a memory 208 where packets to be transmitted are temporarily stored. Each packet may have a given quality of service (QoS) value. The packets may be packets of one or more logical channels. Each packet may also have a priority value. The transceiver comprises a receiver unit 222 and a transmitter unit 224. The complete structure of transceivers 200 and 202 is omitted for simplicity. The first transceiver 200 further comprises a controller 210 controlling the operation of the transceiver. The receiver 222 and transmitter 224 may comprise a separate controller. The first transceiver 200 may utilize more than one transmission stream 212, 214 when transmitting to the second transceiver 202. The streams may be realized with more than one transmit antenna path 216, 218.

For each packet to be transmitted, the controller 210 is configured to select the stream to be used in the transmission of the packet. In an embodiment, the second transceiver 202 receiving the streams 212, 214 may transmit channel quality information 220 of each available stream back to the first transceiver 200. The first transceiver may comprise a receiver 222 for receiving said information. The information may be the signal to interference ratio of each stream, for example. Based on the quality of service value or priority value of data to be transmitted, the controller selects how data is mapped to transmission streams having certain channel quality information. In an embodiment, the quality of service value determines the stream with which a logical channel is transmitted, and packets are formed on the basis of the channel quality information of the stream so that a desired retransmission probability may be achieved.

In an embodiment, the second transceiver 202 may transmit packets to the first transceiver 200 using the same frequency band as the first transceiver 200. Thus, the transceivers may use time division duplex. In such a case, the first transceiver 200 may determine channel quality information from the transmission of the second transceiver.

In the first transceiver 200, the packets to be transmitted may be temporarily stored in memory 208. These packets may be packets of one or more logical channels. For example, the first transceiver 200 may transmit a control channel and a traffic channel to the second transceiver 202. These channels may have a different quality of service requirement. The quality of service value of each packet may depend upon the quality of service requirement of respective logical channel.

Furthermore, the transceivers may utilise HARQ in the transmission. In HARQ, packets unsuccessfully received by the second transceiver 202 are retransmitted by the first transceiver 200. The retransmitted packets may have a different quality of service value than packets sent for the first time.

FIG. 3 is a flowchart illustrating an embodiment of the invention. In step 300, a transmitter receives packets to be transmitted from one or more logical channel sources. The packets have a given quality of service value and priority. The transmitter stores the packets temporarily in a memory or a buffer.

In step 302, the transmitter checks the channel quality information of streams that are available. The channel quality information may be received from the transceiver receiving the streams, or the transmitter itself may obtain the information.

In step 304, the transmitter selects how data is mapped to transmission streams having certain channel quality information. The selection may be based on the quality of service value or priority value of data to be transmitted. In an embodiment, the quality of service value determines the stream with which a logical channel is transmitted, and packets are formed on the basis of the channel quality information of the stream so that a desired retransmission probability may be achieved. For example, a packet with a high priority value may be forwarded to a stream fulfilling the desired quality criterion. In an embodiment, the purpose of the selection of the stream is to maximise the instantaneous throughput of the transmission.

Let us study an example of stream selection. Let us assume that two streams are supported and that the quality CQI₁ of the first stream is greater than the quality CQI₂ of the second stream. Furthermore, let us assume that two priority queues or logical channels are present and that the quality of service requirement QoS₁ of the first logical channel is higher than the quality of service requirement Qos₂ of the second logical channel and that the first logical channel consists of low data rate signalling information and the second logical channel consist of high data rate non-real time data. The quality of both first and second streams (CQI₁ and CQI₂) is sufficient to fulfil the quality of service requirement QoS₁ of the first logical channel (or first priority queue). In this case, the first logical channel could be allocated to the first stream or similarly to the second stream. However, as the quality CQI₂ of the second stream would be sufficient to fulfil the QoS₁ requirement of the first logical channel and the second stream would offer higher throughput (via better CQI) for the second logical channel, it would be more optimal from system capacity perspective to allocate the first logical channel to the second stream and the second logical channel to the first stream (or data from the first priority queue to the second stream and vice versa).

In step 306, the packet is forwarded to transmission units of the transmitter.

In step 308, it is checked whether a new packet is ready to be transmitted. If this is the case, the process continues from step 300.

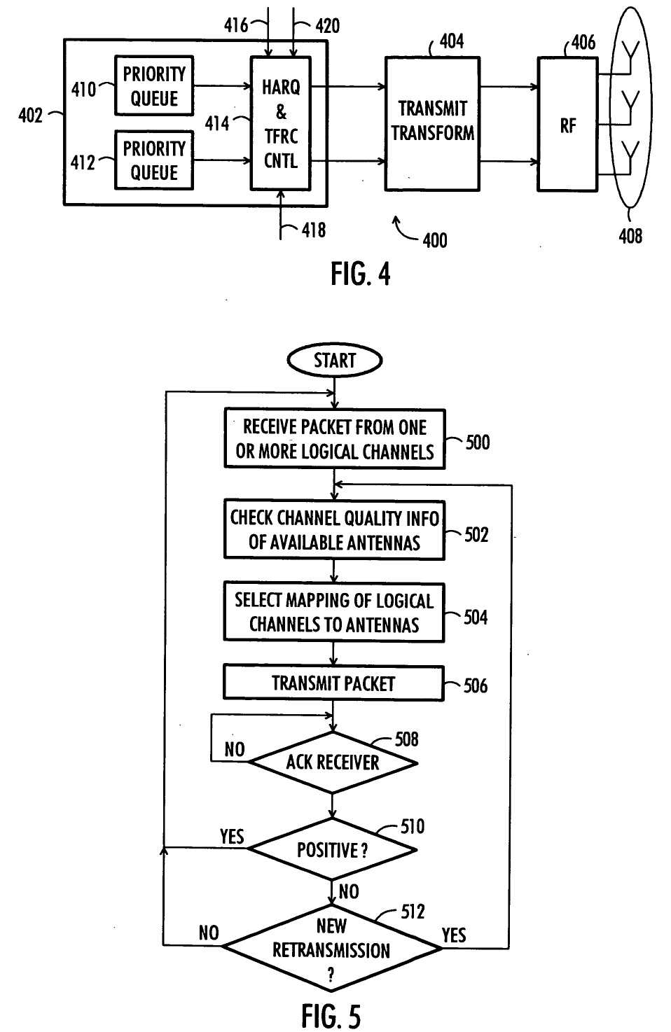

FIG. 4 illustrates a more detailed example of an embodiment of the invention. FIG. 4 shows a transmitter 400 configured to transmit packets to a receiver (not shown). The transmitter comprises a packet multiplexer unit 402, transmit transform unit 404, radio frequency unit 406 and antennas 408.

The packet multiplexer unit 402 comprises one or more priority queues 410, 412 comprising packets of logical channels. The queues may have different relative priorities depending on quality of service requirements. The queues may be realised with one or more memories or buffers. The outputs of the queues are operationally connected to a controller 414. The controller is responsible for selecting streams for packets to be transmitted. The controller is also responsible for retransmission control. The controller 414 receives information 416 about the quality of service and priority status of each queue and packet, channel quality information 418 regarding available streams and retransmission information 420.

The channel quality information 418 may come as a feedback from the receiver of the packets (not shown). The receiver receives the streams used by the transmitter and measures the signal to interference ratio (SIR) of the streams, for example. The measurement results or information about the measurement results is sent back to the transmitter of the packets.

The controller 414 is also configured to act as a HARQ control entity. The HARQ entity controls the physical layer retransmissions. When a packet is transmitted, the controller is configured to wait for an acknowledgement from the receiver. The acknowledgement may be a positive acknowledgement (ACK) or a negative acknowledgement (NAK). In the case of NAK, a new priority value is estimated for the packet to be retransmitted. If the priority value exceeds the values of the packets in the queue, the packet is retransmitted immediately and a new packet from the queues 410, 412 is accepted for transmission when the previous packet has been transmitted and capacity for a new packet transmission is available. In the case of ACK, a new packet is taken from the queues 410, 412 for transmission.

When a packet is to be transmitted, the controller 414 selects the transport format and resource combination (TFRC) including the physical layer transport block size, the used physical layer modulation and the number of used channelisation codes, depending on the quality of the selected stream. The controller 414 is further configured to select the number of streams available at any given moment.

In an embodiment, the controller 414 selects the stream for each packet so that the instantaneous throughput and quality of service of the transmission is optimized. In WCDMA, the transport block sizes and number of streams may be selected by trying to maximise information rate that can be transmitted through the channel with certain reliability.

From the controller 414, the streams to be transmitted are forwarded to the transmit transformer 404. The transmit transformer 404 maps the streams to the transmit antennas 408 via the radio frequency unit 406. In the transmit transformer 404, several techniques to map the streams may be used. These techniques are known to one skilled in the art.

In an embodiment, the streams are realised with beamforming. In beamforming, the signal to be transmitted is multiplied with beam coefficients which phase the signal in such a way, that when the signal is transmitted using multiple antennas or an antenna array, several beams are created. By phasing the input signal of each antenna in a suitable manner, the antennas produce beams which may have different directions and radiation patterns. The transmit transformer 404 may determine suitable beam coefficients.

In an embodiment, the streams are realised with Per-Antenna Rate Control (PARC). PARC is a method proposed to be used on High Speed Packet Downlink Access (HSPDA) connections in UMTS. In PARC, each antenna transmits a separately encoded data stream. The data rate of each stream is separately controlled. The receiver may measure the SIR of each stream and report results back to the transmitter. If the quality of a signal transmitted by a given antenna is too low for the transmission of a queue 410, 412, then the antenna is not used for data transmission. However, the antenna may transmit a pilot signal, so that the quality of the stream may be monitored. When the quality increases, the antenna may be taken into use again. In PARC, the transmit transformer 404 may use an identity matrix for mapping transformation.

Other modulation mappings may also be used in addition to PARC and beamforming, as a person skilled in the art understands.

FIG. 5 illustrates an embodiment where HARQ is utilised. In this example, the antenna used for the transmission and retransmission of the packets is selected on the basis of channel quality information. It should be noted that the embodiment is applicable to all cases where the stream used for transmission is selected.

In step 500, a transmitter receives packets to be transmitted from one or more logical channel sources. The packets have a given quality of service value and priority. The transmitter stores the packets temporarily in a memory or a buffer.

In step 502, the transmitter checks the channel quality information of available antennas. The channel quality information may be received from the transceiver receiving the transmissions, or the transmitter itself may obtain the information.

In step 504, the transmitter selects how to map data to transmission antennas having certain channel quality information. The selection may be based on the quality of service value or priority value of data to be transmitted. In an embodiment, the quality of service value determines the antenna with which a logical channel is transmitted, and packets are formed on the basis of the channel quality information of the antenna so that a desired retransmission probability may be achieved.

In step 506, the packet is transmitted.

In step 508, it is checked whether an acknowledgement has been received from the transceiver receiving the transmissions.

If this is the case, it is checked in step 510 whether the acknowledgement was a positive or a negative acknowledgement. In the case of a positive acknowledgement the process continues from step 500.

In the case of a negative acknowledgement, the transmitter checks 512 whether the packet is retransmitted. In an embodiment, the number of retransmissions is restricted and if the packet has already been retransmitted a number of times without success, the packet may be discarded and a new packet is transmitted. In such a case, the process continues from step 500.

If packet must be retransmitted, the process continues from step 502. The retransmission is processed as a first transmission and the antenna is selected in a similar manner. Thus, a different antenna may be used in the retransmission than in a previous transmission.

The above description is a simplified example and some steps are omitted for simplicity, as a person skilled in the art understands. For example, if a retransmission of a packet is required but a new packet which has not yet been transmitted has a higher priority than the packet to be retransmitted, the new packet may be transmitted first.

In some embodiments, more than one packet is transmitted simultaneously from different antennas or using different streams. Thus, a retransmission of a packet using a given antenna or a stream may occur simultaneously with a first transmission of a new packet using a different antenna or a stream.

Embodiments of the invention may be realized in a base station or a mobile station of a telecommunication system. The base station or mobile station may comprise a controller configured to perform at least some of the steps described in connection with the flowcharts of FIGS. 3 and 5 and in connection with FIGS. 2 and 4. Embodiments may be implemented as a computer program embodied within a computer readable medium, the computer program including instructions for executing a computer process for controlling packet data transmission in a radio system, each packet having a given quality of service value, the process comprising: selecting a stream of two or more available streams realized with a plurality of transmit antenna paths for the transmission of each packet on the basis of the quality of service value of each packet and the channel quality information of each available stream.

The computer readable medium may be, for example but not limited to, an electric, magnetic, optical, infrared or semiconductor system, device or transmission medium. The computer readable medium may include at least one of the following media: a computer readable medium, a program storage medium, a record medium, a computer readable memory, a random access memory, an erasable programmable read-only memory, a computer readable software distribution package, a computer readable signal, a computer readable telecommunication signal, computer readable printed matter, and a computer readable compressed software package.

Even though the invention has been described above with reference to an example according to the accompanying drawings, it is clear that the invention is not restricted thereto but can be modified in several ways within the scope of the appended claims.

1. A method of controlling data transmission in a radio system, the method comprising:
transmitting packets from a first transceiver to a second transceiver, each packet having a given quality of service value; and
selecting in the first transceiver, a stream of two or more available streams realized with a plurality of transmit antenna paths for the transmission of each packet on the basis of the quality of service value of each packet and a channel quality information of each of the two or more available streams.

2. The method of claim 1, further comprising:
receiving, by the first transceiver, the channel quality information of each of the two or more available streams transmitted by the second transceiver.

3. The method of claim 1, further comprising: storing packets to be transmitted in a memory with information about the quality of service value of each packet.

4. The method of claim 3, further comprising:
receiving a request to retransmit at least one packet;
determining the quality of service value for a packet to be retransmitted; and
storing the packet to be retransmitted in the memory.

5. The method of claim 1, further comprising:
detecting a failure in reception of at least one packet in the second transceiver; and
transmitting, from the second transceiver to the first transceiver, a request to retransmit at least one packet having a failure in reception.

6. A transceiver of a telecommunication system, the transceiver comprising:
a transmitter for transmitting packets to a second transceiver, each packet having a given quality of service value;
a plurality of transmit antenna paths operationally connected to the transmitter; and
a controller, operationally connected to the transmitter, for selecting a stream of two or more available streams realized with a plurality of transmit antenna paths for the transmission of each packet on the basis of the quality of service value of each packet and a channel quality information of each of the two or more available streams.

7. The transceiver of claim 6, further comprising a receiver, operationally connected to the transmitter, for receiving the channel quality information of each of the two or more available streams transmitted by the second transceiver.

8. The transceiver of claim 6, further comprising a receiver, operationally connected to the transmitter, for measuring the channel quality information of each of the two or more available streams from a signal transmitted by the second transceiver.

9. The transceiver of claim 6, further comprising a receiver, operationally connected to the transmitter, for receiving from the second transceiver a request to retransmit at least one packet having failure in reception.

10. The transceiver of claim 9, wherein the controller is configured to determine the quality of service value for a packet to be retransmitted.

11. A telecommunication system, comprising a first and a second transceiver, the first transceiver comprising:
a transmitter for transmitting packets to the second transceiver, each packet having a given quality of service value;
a plurality of transmit antenna paths operationally connected to the transmitter; and
the first transceiver being configured to select a stream of two or more available streams realized with a plurality of transmit antenna paths for the transmission of each packet on the basis of the quality of service value of each packet and a channel quality information of each of the two or more available stream.

12. A telecommunication system of claim 11, wherein the second transceiver is configured to transmit to the first transceiver, information about a quality of the signal of each available stream.

13. A telecommunication system of claim 11, wherein the second transceiver is configured to
detect a failure in reception of at least one packet; and
transmit to the first transceiver a request to retransmit the at least one packet having a failure in reception.

14. A telecommunication system of claim 13, wherein the first transceiver is configured to
receive from the second transceiver a request to retransmit at least one packet having failure in reception; and
determine the quality of service value for a packet to be retransmitted.

15. A base station of a telecommunication system, the base station comprising:
a transmitter for transmitting packets, each packet having a given quality of service value;
a plurality of transmit antenna paths operationally connected to the transmitter;
a controller, operationally connected to the transmitter, for selecting a stream of two or more available streams realized with the plurality of transmit antenna paths for the transmission of each packet on the basis of the quality of service value of each packet and a channel quality information of each of the two or more available stream.

16. A data transmission method in a telecommunication system, the method comprising:
transmitting packets from a first transceiver to a second transceiver utilising a transmit antenna path of at least two available transmit antenna paths;
detecting a failure in the reception in the second transceiver;
transmitting, from the second transceiver to the first transceiver, a request to retransmit at least one packet having failure in reception;
transmitting, from the second transceiver to the first transceiver, information about a quality of a signal sent using different transmit antenna paths;
selecting a transmit antenna path on the basis of the information; and
retransmitting, from the first transceiver, at least one packet requested in response to the request utilising the selected transmit antenna path.

17. The method of claim 16, further comprising: selecting the transmit antenna path that gives a best instantaneous signal quality in the second transceiver.

18. The method of claim 16, further comprising: performing signal quality measurements in the second transceiver.

19. The method of claim 18, wherein the second transceiver performs signal to noise and interference ratio measurements of signals transmitted by the first transceiver with different transmit antenna paths.

20. A telecommunication system comprising a first and a second transceiver, the first transceiver being configured to:
transmit packets to the second transceiver utilising one or more transmit antenna paths from a plurality of transmit antenna paths;
the second transceiver being configured to:
detect a failure in reception;
transmit to the first transceiver a request to retransmit at least one packet having failure in reception; and
transmit to the first transceiver, information about a quality of a signal sent using different transmit antenna paths;
the first transceiver being further configured to:
select a transmit antenna path on the basis of the information;
retransmit at least one packet requested in response to the request utilising the selected transmit antenna path.

21. A data transmission method in a transceiver of a telecommunication system, the method comprising:
transmitting packets to a another transceiver utilising one or more transmit antenna paths from a plurality of transmit antenna paths;
receiving from the another transceiver a request to retransmit at least one packet having failure in reception and information about a quality of the signal sent using different transmit antenna paths;
selecting a transmit antenna path on the basis of the information; and
retransmitting at least one packet requested in response to the request utilising the selected transmit antenna path.

22. A transceiver of a telecommunication system, the transceiver comprising:
a transmitter for transmitting packets to another transceiver utilising one or more transmit antenna paths from a plurality of transmit antenna paths;
a receiver, operationally connected to the transmitter, for receiving from the another transceiver, a request to retransmit at least one packet having a failure in reception and information about the quality of the signal sent using different transmit antenna paths; and
a controller, operationally connected to the transmitter and the receiver, for selecting a transmit antenna path on the basis of the information and for controlling the transmitter to retransmit at least one packet requested in response to the request utilising a selected transmit antenna path.

23. The transceiver of claim 22, wherein the controller is configured to select the transmit antenna path that gives a best instantaneous signal quality in the another transceiver.

24. A base station of a telecommunication system, the base station comprising:
a transmitter for transmitting packets to another transceiver utilising one or more transmit antenna paths from a plurality of transmit antenna paths;
a receiver, operationally connected to the receiver, for receiving from the another transceiver, a request to retransmit at least one packet having failure in reception and information about a quality of the signal sent using different transmit antenna paths; and
a controller, operationally connected to the transmitter and the receiver, for selecting a transmit antenna path on the basis of the information and for controlling the transmitter to retransmit at least one packet requested in response to the request utilising the selected transmit antenna path.

25. A transmitter of a telecommunication system, the transmitter comprising a plurality of transmit antenna paths, the transmitter being configured to transmit packets, each packet having a given quality of service value, and to select a stream of two or more available streams realized with a plurality of transmit antenna paths for the transmission of each packet on the basis of a quality of service value of each packet and a channel quality information of each available stream.

26. A computer program embodied within a computer readable medium, the computer program including instructions for executing a computer process for controlling packet data transmission in a radio system, each packet having a given quality of service value, the process comprising:
selecting a stream of two or more available streams realized with a plurality of transmit antenna paths for the transmission of each packet on the basis of the quality of service value of each packet and the channel quality information of each available stream.

27. A transceiver of a telecommunication system, the transceiver comprising:
means for transmitting packets to a second transceiver, each packet having a given quality of service value;
a plurality of transmit antenna paths means that are operationally connected to the means for transmitting; and
means for controlling, operationally connected to the transmitter, for selecting a stream of two or more available streams realized with a plurality of transmit antenna paths for the transmission of each packet on the basis of the quality of service value of each packet and the channel quality information of each available stream.
